(19) United States
(12) Patent Application Publication
(10) Pub. No.: US 2026/0254479 A1
(43) Pub. Date: Aug. 27, 2026

(54) LOW POWER AND LOW COST ACTIVE CABLE ARCHITECTURE

(71) Applicant: Lerain Technology Co., Ltd., New Taipei City (TW)

(72) Inventors: MIAOBIN GAO, New Taipei City (TW); HENG-JU CHENG, New Taipei City (TW); HSIN-CHE CHIANG, New Taipei City (TW); CHE-YING LI, New Taipei City (TW); WEN-SHENG YANG, New Taipei City (TW)

(21) Appl. No.: 19/231,704

(22) Filed: Jun. 9, 2025

(30) Foreign Application Priority Data
Feb. 25, 2025 (TW) 114106982

(51) Int. Cl. H04B 3/36

(52) U.S. Cl. CPC H04B 3/36

(57) ABSTRACT

An active cable architecture is disclosed. The active cable architecture is designed to connect a first and second electronic device. The active cable architecture includes a first and second connection port, first and second repeaters, a plurality of high-speed transmission wires, and a main communication processor. The first and second repeaters are disposed within the first and second connection ports, respectively. The high-speed transmission wires connect the first and second repeaters. The main communication processor is disposed within either the first or second connection port, connecting one repeater and controlling the synchronized communication functions of the first and second repeaters.

### BACKGROUND OF THE INVENTION

### 1. Field of the Invention

The present invention relates to an active cable architecture, particularly to an active cable architecture that achieves synchronized communication at both ends.

### 2. Description of the Related Art

With the advancement of technology, the data transmission rate of communication transmission cables has been steadily increasing, such as with communication transmission cables of specifications or models like USB4 V2, DP80, TBT5, and PCIe Gen6/7. At the same time, the length of the transmission cables also needs to be considered. As a result, the demand for active transmission cables has increased. The connectors at both ends of the active transmission cable contain repeaters to compensate for high-frequency signal loss caused by the cable, ensuring that high-speed signals are accurately reproduced when they reach the destination. The repeater is internally configured with a communication interface to input and read data, serving as the interface to control the repeater, such as an I2C (Inter-Integrated Circuit) or System Management Bus (SMBus) type SIPO (Serial-In, Parallel-Out) two-wire synchronous communication interface. This two-wire synchronous communication requires a communication processor as the master, with the repeater functioning as the slave for control.

Please refer to FIG. 1, which illustrates a schematic diagram of the architecture of an active cable architecture connection of the prior art.

In the prior art, the active cable architecture 90 connects different electronic devices via a first connection port 91, a second connection port 92, and a transmission wire 94. The first connection port 91 includes a first repeater 931 and a first communication processor 951, while the second connection port 92 includes a second repeater 932 and a second communication processor 952. The first repeater 931 and the second repeater 932 can adjust the parameters of the transmission wire 94, for example, by adjusting the transmission direction or the transmission gain. Since the active cable includes two repeaters, traditional active cables also employ two processors to control and configure the repeaters at both ends. The input and reading of the first repeater 931 and the second repeater 932 are controlled by the first communication processor 951 and the second communication processor 952 to achieve synchronized control. However, the use of two communication processors results in higher power consumption compared to conventional passive cables and significantly increases the manufacturing cost.

Therefore, there is a need to invent a new active cable architecture to address the shortcomings of the prior art.

### SUMMARY OF THE INVENTION

The main objective of the present invention is to provide an active cable architecture that achieves synchronized communication at both ends.

To achieve the above objective, the active cable architecture of the present invention is configured to be connected between a first electronic device and a second electronic device. The active cable architecture includes a first connection port, a second connection port, a first repeater, a second repeater, a plurality of high-speed transmission wires, and a main communication processor. The first connection port or the second connection port is adapted to be connected to the first electronic device or the second electronic device. The first repeater is disposed within the first connection port, and the second repeater is disposed within the second connection port. A plurality of high-speed transmission wires connect the first repeater and the second repeater, enabling signal transmission between the first electronic device and the second electronic device via the first connection port, the second connection port, and the high-speed transmission wires. The main communication processor is disposed within either the first connection port or the second connection port, electrically connected to the repeater within the same port, and also electrically connected to the other repeater within the other connection port. In this way, the main communication processor can control the synchronized communication functions of the first repeater and the second repeater.

In one embodiment of the active cable architecture of the present invention, the main communication processor is disposed within the first connection port, electrically connected to the first repeater within the first connection port and the second repeater within the second connection port via a non-high-speed transmission wire.

In one embodiment of the active cable architecture of the present invention, the main communication processor is disposed within the second connection port, electrically connected to the second repeater within the second connection port and the first repeater within the first connection port via a non-high-speed transmission wire.

In one embodiment of the active cable architecture of the present invention, the communication addresses of the first repeater and the second repeater are different.

### BRIEF DESCRIPTION OF THE DRAWINGS

All of the objects and advantages of the present invention will become apparent from the following description of the accompanying drawings, which disclose several embodiments of the present invention. It should be understood that the drawings are used for purposes of illustration only, and not as a definition of the invention.

FIG. 1 illustrates a schematic diagram of the architecture of an active cable architecture connection of the prior art.

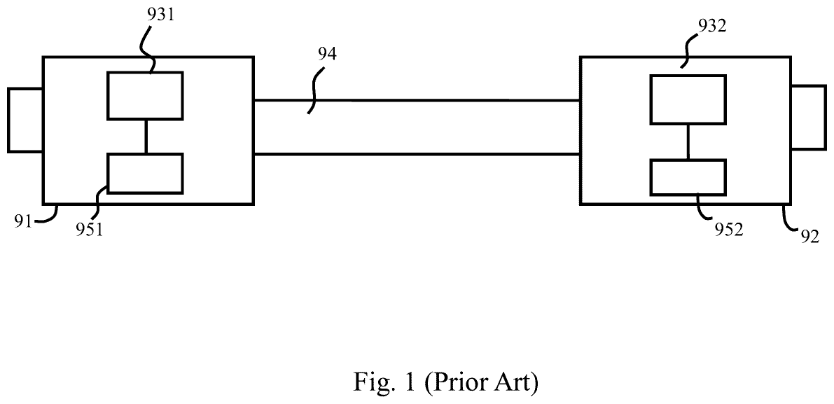

FIG. 2 illustrates a schematic diagram of the architecture of a first embodiment of the active cable architecture of the present invention.

FIG. 3 illustrates a schematic diagram of the architecture of a second embodiment of the active cable architecture of the present invention.

### DETAILED DESCRIPTION OF THE PREFERRED EMBODIMENT S

Preferred specific embodiments are given below for better understanding of the technical contents of the present invention.

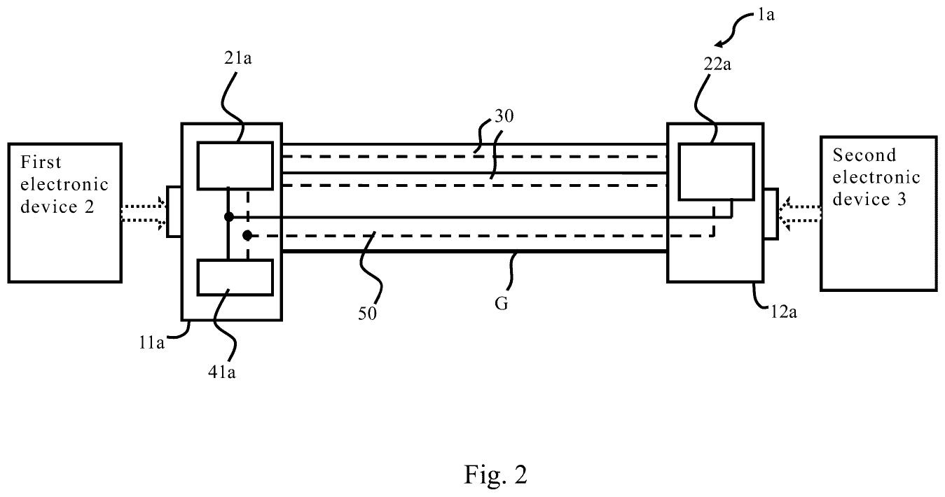

Please refer to FIG. 2, which illustrates a schematic diagram of the architecture of the first embodiment of the active cable architecture of the present invention.

In the first embodiment of the present invention, the active cable architecture 1a connects a first electronic device 2 and a second electronic device 3 via a first connection port 11a and a second connection port 12a. The first electronic device 2 and the second electronic device 3 can be, for example, a desktop computer system, a laptop, a smartphone, a tablet, a wearable device, or a display monitor. The first electronic device 2 can be configured as the main host for controlling and outputting signals, while the second electronic device 3 can be configured as the device to which signals are to be connected and received. However, the invention is not limited to these examples. In the embodiment of the present invention, the signal is transmitted from the first connection port 11a to the second connection port 12a as a forward transmission, and from the second connection port 12a to the first connection port 11a as a reverse transmission. However, the forward and reverse transmission terms are used for illustrative purposes in the specification, and the invention is not limited to these terms. Since the connection method of the active cable architecture 1a is well-known to those skilled in the technical field to which the present invention pertains, it will not be further elaborated here.

In the first embodiment of the present invention, the active cable architecture 1a includes a first connection port 11a, a second connection port 12a, a first repeater 21a, a second repeater 22a, a plurality of high-speed transmission wires 30, a main communication processor 41a, and a non-high-speed transmission wire 50. The first repeater 21a and the second repeater 22a are symmetrically disposed on the circuit board (not shown) inside the first connection port 11a and the second connection port 12a. The first repeater 21a and the second repeater 22a have adjustable parameters that can modify the direction of signal transmission, that is, setting the plurality of high-speed transmission wires 30 for forward or reverse transmission, as well as adjusting the gain or equalization values of the signal to compensate for signal attenuation or distortion caused during the transmission process. The invention does not limit the functions of the first repeater 21a and the second repeater 22a.

The first connection port 11a and the second connection port 12a are electrically connected to the plurality of high-speed transmission wires 30 through their respective internal pins. In this way, the first electronic device 2 can be electrically connected to the first connection port 11a, the second electronic device 3 can be electrically connected to the second connection port 12a, and signals can be transmitted in either the forward or reverse direction via the high-speed transmission wires 30. It is important to note that each set of high-speed transmission wires 30 has a positive and a negative channel, as indicated by solid lines representing the positive channel and dashed lines representing the negative channel in FIG. 2. Thus, FIG. 2 shows two sets of high-speed transmission wires 30. However, the number of high-speed transmission wires 30 in FIG. 2 is merely for illustration; the actual number can be adjusted based on the specifications of the first repeater 21a and the second repeater 22a, and the invention is not limited to this.

In the first embodiment of the present invention, the active cable architecture 1a also includes a main communication processor 41a. The main communication processor 41a is disposed within the first connection port 11a. In FIG. 2, the first repeater 21a and the main communication processor 41a are both disposed on the circuit board inside the first connection port 11a, while the non-high-speed transmission wire 50 connects the first repeater 21a, the main communication processor 41a, and the second repeater 22a. This configuration allows the first repeater 21a and the main communication processor 41a to be directly electrically connected via the non-high-speed transmission wire 50, and the main communication processor 41a is then connected to the second repeater 22a in the second connection port 12a using the non-high-speed transmission wire 50. The communication addresses of the first repeater 21a and the second repeater 22a are different. Thus, regardless of whether the first connection port 11a or the second connection port 12a is the remote or local port, the main communication processor 41a can distinguish between the first repeater 21a and the second repeater 22a and control the synchronized communication functions of the two repeaters. In this embodiment, there is no need to set up another communication processor in the second connection port 12a. Additionally, a ground cable G is provided between the first connection port 11a and the second connection port 12a. The plurality of high-speed transmission wires 30, the non-high-speed transmission wire 50, and the ground cable G can be enclosed within the same insulating jacket, but the invention is not limited to this.

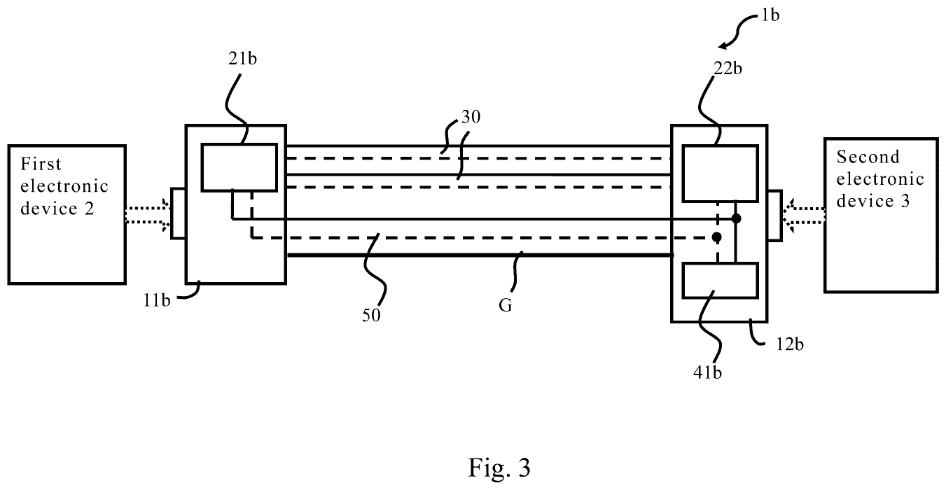

Next, please refer to FIG. 3, which illustrates a schematic diagram of the architecture of the second embodiment of the active cable architecture of the present invention.

In the second embodiment of the present invention, the active cable architecture 1b includes a first connection port 11b, a second connection port 12b, a first repeater 21b, a second repeater 22b, a plurality of high-speed transmission wires 30, a main communication processor 41b, and a non-high-speed transmission wire 50. The first repeater 21b and the second repeater 22b are symmetrically disposed inside the first connection port 11b and the second connection port 12b. The first connection port 11b and the second connection port 12b are electrically connected to the plurality of high-speed transmission wires 30 through their respective internal pins. Unlike the first embodiment, in the second embodiment, the main communication processor 41b is disposed within the second connection port 12b, so that the second repeater 22b and the main communication processor 41b are directly electrically connected via the non-high-speed transmission wire 50. The main communication processor 41b then connects to the first repeater 21b in the first connection port 11b via the non-high-speed transmission wire 50. The communication addresses of the first repeater 21b and the second repeater 22b are different, allowing the main communication processor 41b to distinguish between the first repeater 21b and the second repeater 22b and control them to achieve synchronized communication.

As described above, the main communication processors 41a and 41b of the active cable architecture 1a and 1b of the present invention can be disposed within a connection port on one side to achieve synchronized communication. This configuration effectively saves space, reduces the cable power consumption, minimizes the number of processor programming cycles, and ultimately results in reduced power consumption and manufacturing costs.

It is noted that the above-mentioned embodiments are only for illustration. It is intended that the present invention covers modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An active cable architecture, configured to be connected between a first electronic device and a second electronic device, comprising:
a first connector port;
a second connector port, wherein either the first connection port or the second connection port is adapted to be connected to the first electronic device or the second electronic device;
a first repeater, disposed within the first connection port;
a second repeater, disposed within the second connection port;
a plurality of high-speed transmission wires, connecting between the first repeater and the second repeater, thereby enabling signal transmission between the first electronic device and the second electronic device through the first connection port, the second connection port, and the plurality of high-speed transmission wires; and
a main communication processor, disposed within one of the first connection port or the second connection port, electrically connected to either the first repeater or the second repeater, and also electrically connected to the other repeater disposed in the other connection port, wherein the main communication processor is configured to control the synchronization communication function of the first repeater and the second repeater.

2. The active cable architecture as claimed in claim 1, wherein the main communication processor is disposed within the first connection port, electrically connected to the first repeater within the first connection port and the second repeater within the second connection port via a non-high-speed transmission wire.

3. The active cable architecture as claimed in claim 1, wherein the main communication processor is disposed within the second connection port, electrically connected to the second repeater within the second connection port and the first repeater within the first connection port via a non-high-speed transmission wire.

4. The active cable architecture as claimed in claim 1, wherein the communication addresses of the first repeater and the second repeater are different.
